(19) United States
(12) Patent Application Publication
(10) Pub. No.: US 2010/0262991 A1
(43) Pub. Date: Oct. 14, 2010

(54) METHOD FOR PROCESSING DATA AND IPTV RECEIVING DEVICE

(75) Inventors: Koo Yong Pak, Seoul (KR); Sung Hyun Cho, Seoul (KR); Il Gon Park, Seoul (KR); Kumar K. Kiran, Seoul (KR); Min Gyu Chung, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/740,697

(22) PCT Filed: Oct. 30, 2008
(86) PCT No.: PCT/KR2008/006424

§ 371 Date: Apr. 30, 2010

Related U.S. Application Data
(60) Provisional application No. 60/984,714, filed on Nov. 1, 2007.
(60) Provisional application No. 60/986,603, filed on Nov. 9, 2007.
(60) Provisional application No. 61/020,136, filed on Jan. 9, 2008.

(51) Int. Cl. H04N 7/167

(52) U.S. Cl. 725/31

(57) ABSTRACT

Disclosed are a data processing method and an IPTV receiving device. The data processing method includes a data processing method of a DRM component of an IPTV receiving device. A packet to be decrypted and its associated information are received from a server. The packet is decrypted by performing any one of its own decryption and decryption using external hardware. In the case in which the its own decryption is performed, the packet is received and decrypted using internal software. In the case in which the decryption using the external hardware is performed, an external trusted hardware component within the IPTV receiving device is exchanged with a key.

### TECHNICAL FIELD

The present invention relates to a data processing method and an IPTV receiving device, and more particularly, to IPTV security related technologies, which can provide functions and operating scenarios of DRM components of an IPTV receiving device.

### BACKGROUND ART

Recently, as digital broadcast environment is configured and the needs for a high picture quality and various supplementary services increase rapidly, digital broadcast service has been commercialized. Digital broadcast service can offer a high quality of service, which could not be provided in existing analog broadcast service.

In particular, IPTV (Internet Protocol Television) service providing broadcast service over an IP network can provide a high picture quality of broadcast content and also permits bidirectional service, which enables a user to actively select the type, the audience time, etc. of a viewing program. The IPTV service can also provide a variety of supplementary services, for example, Internet search, home shopping, online game and so on in conjunction with broadcast based on such bidirectionality.

For such an IPTV service, a service system and a user system can be required. The service system can be provided with various pieces of content from content providers, and it can generate guide information, for example, EPG (Electronic Program Guide, IPG (Interactive Program Guide), CPG (Content Program Guide), and so on, including a service content list, a broadcast schedule, a preview, etc., and provide it to the user system over an IP network.

The user system includes an IPTV device (for example, an IPTV settop box) and the like. The user system can display guide information provided from the service provider and request content or service, which is selected by a user, from the service system. Meanwhile, the user system can include a user domain. Content received by the IPTV device on the user side may be shared by devices, for example, home network devices within the user domain.

In order to stably operate this IPTV system, when the user system receives and uses IPTV service related data, for example, content, messages, software, security information, etc., the IPTV service related data needs to be processed while safely protecting it from unpermitted and illegal acts.

Accordingly, a security system capable of guaranteeing the security of IPTV service has to be indispensably used in the user system. The security system must be able to define security modules and efficiently present operating procedures of the defined security modules and an association scenario with external entities. Thus, there is an urgent need for security related technologies, which can guarantee the security of a user system in an IPTV system.

### DISCLOSURE OF INVENTION

### Technical Problem

Accordingly, an object of the present invention is to provide a data processing method of presenting functions and operating scenarios of DRM components included in an IPTV receiving device and efficiently processing data using the functions and operating scenarios, and an IPTV receiving device equipped with the data processing method.

### Technical Solution

To achieve the above object, an aspect of the present invention provides a data processing method. The data processing method includes, the steps of receiving information associated with a packet to be decrypted from a server; and decrypting the packet by performing any one of its own decryption and decryption using external hardware. In the case in which the its own decryption is performed, the DRM component receives the packet and decrypts the packet using internal software, and in the case in which the decryption using the external hardware is performed, the DRM component exchanges a key with an external trusted hardware component within the IPTV receiving device.

The data processing method may further include the steps of configuring reception and filtering of a DRM message, which are performed by an external component within the IPTV receiving device; and receiving DRM parameters from the external component. Further, the data processing method may further include the step of communicating with a DRM server in order to exchange a key and rights necessary for the decryption.

The data processing method may further include the steps of a DRM server authenticating and provisioning the DRM component; and initializing persistent values necessary for an operation and safely loading the persistent values. The data processing method may further include the step of, in the case in which there are no appropriate rights for decrypting the packet, informing this fact of the IPTV receiving device through a specific message.

The data processing method may further include the step of determining whether the its own decryption or the decryption using the external hardware will be performed based on the received information. In this case, the determination step may be performed by determining whether internal software capable of performing the decryption of the packet or based on specification by the received information.

Meanwhile, to achieve the above object, an aspect of the present invention provides an IPTV receiving device, including hardware component; and a DRM component receiving a packet to be decrypted and its associated information from a server, and decrypting the packet by performing any one of its own decryption and decryption using external hardware. In the case in which the its own decryption is performed, the DRM component receives the packet and decrypts the packet using internal software, and in the case in which the decryption using the external hardware is performed, the DRM component exchanges a key with the hardware component.

Further, the IPTV receiving device may further include a filtering component for receiving and filtering a DRM message. The DRM component may configure reception and filtering of the DRM message, which are performed by the filtering component, and receive DRM parameters from the filtering component.

The DRM component may determine whether the its own decryption or the decryption using the external hardware will be performed based on the received information.

### Advantageous Effects

As described above, according to the present invention, there are provided functions and operating scenarios of DRM components of an IPTV receiving device. Accordingly, security related data can be processed efficiently using the DRM components.

### BRIEF DESCRIPTION OF DRAWINGS

FIG. 1 is a block diagram showing DRM components of an IPTV system for IPTV service;

FIG. 2 is an exemplary view showing an operation of an IPTV receiving device DRM component in accordance with an embodiment of the present invention;

FIG. 3 is an exemplary view showing an association operation between a CAS system and a DRM system;

FIG. 4 is an exemplary view showing a DSF initialization procedure and illustrates constituent elements related to a DSF and an initialization operation flow thereof;

FIG. 5 is a diagram showing the architecture of an interoperable model;

FIG. 6 is an exemplary view showing a scenario for recording content broadcasted within the IPTV receiving device;

FIG. 7 is an exemplary view showing another scenario for recording content broadcasted within the IPTV receiving device; and

FIG. 8 is an exemplary view showing a scenario for joining the IPTV receiving device in a permitted DRM interoperable domain or a permitted DRM domain.

### MODE FOR THE INVENTION

Hereinafter, the present invention will be described in detail in connection with preferred embodiments with reference to the accompanying drawings in order for those skilled in the art to be able to implement the invention. In the preferred embodiments of the present invention, specific technical terminologies are used for clarity of the contents. However, It is to be understood that the present invention is not limited to specific selected terminologies and each specific terminology includes all technical synonyms operating in a similar way in order to accomplish a similar object.

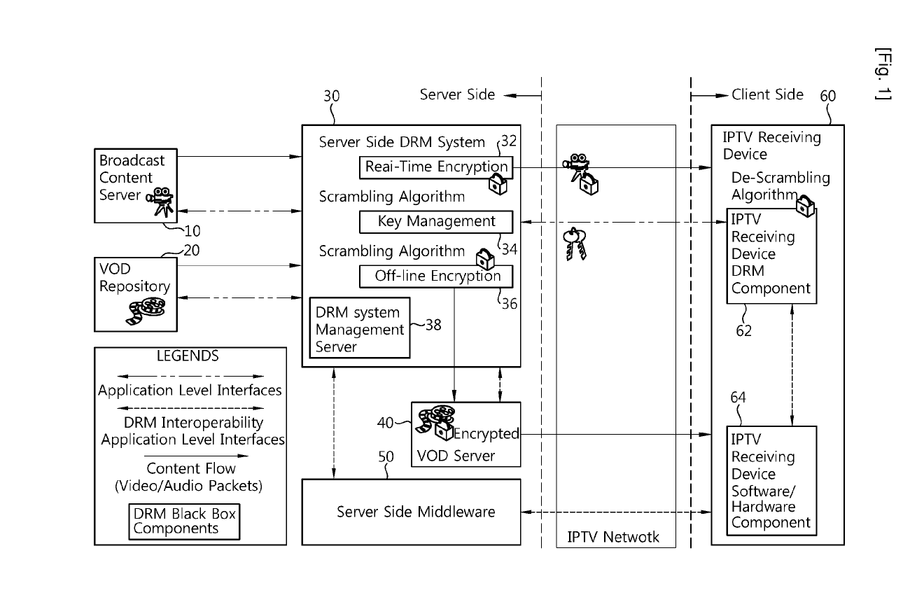

FIG. 1 is a block diagram showing DRM (Digital Rights Management) components of an IPTV system for IPTV service and shows a configuration of the IPTV system for providing IPTV service on the basis of elements necessary for security.

As shown in FIG. 1, a server side DRM system 30 is provided with content from a broadcast content server 10 or a VOD (Video On Demand) repository 20. The server side DRM system 30 may include a realtime encryption module 32, a key management module 34, an offline encryption module 36, a DRM system management server 38 and so on.

The realtime encryption module 32 may encrypt media content provided from the broadcast content server 10 or the VOD repository 20 in real time using a key provided from the key management module 34 and output streams of the encrypted realtime content. The content streams output from the realtime encryption module 32 are transferred to an IPTV receiving device 60. The realtime encryption module 32 may interface with the broadcast content server 10 or the VOD repository 20 in an application level and may also operate in conjunction with the components of the server side DRM system 30, if appropriate.

The offline encryption module 36 receives media content, which will be stored in a VOD server 40, from the broadcast content server 10 or the VOD repository 20 for a specific time period, encrypts the received media content, and provides the encrypted content to the VOD server 40. The offline encryption module 36 is connected to an input port of the VOD server 40. The offline encryption module 36 may interface with the broadcast content server 10 or the VOD repository 20 through an application level and may also operate in conjunction with the components of the server side DRM system 30, if appropriate.

The key management module 34 may provide an appropriate encryption key to the realtime encryption module 32, the offline encryption module 36 or the IPTV receiving device 60 and manage the encryption key. Streams from the key management module 34 may be transferred to the IPTV receiving device 60 and may interface with the IPTV receiving device 60 in an application level.

The DRM system management server 38 functions as a central core of a DRM solution. For example, the DRM system management server 38 may properly control subelements of the server side DRM system 30, for example, the realtime encryption module 32, the key management module 34, the offline encryption module 36, etc. and operate in conjunction with a server side middleware 50. Further, the DRM system management server 38 may provide secure services, for example, authentication, etc. to the components of the server side DRM system 30, an IPTV receiving device DRM component 62 of the IPTV receiving device 60 and the like.

The VOD server 40 may store encrypted content and provide encrypted content in response to a command of the server side middleware 50. An IPTV network provides a route through which a variety of packet streams transmitted from the server side DRM system 30 or the VOD server 40 may be properly transmitted to the IPTV receiving device 60 according to their IP addresses.

The IPTV receiving device 60 may be provided in a client side. The IPTV receiving device 60 provides corresponding functions to a user so that the user may view media content to which rights are assigned (for example, the rights may be obtained by purchasing media content or the like) using the user's viewing device, such as TV. The IPTV receiving device 60 is connected to the IP network and may process, play back or store encrypted content received from the server side DRM system 30 or the VOD server 40. The IPTV receiving device 60 may also redistribute content to devices within a user domain, which are configured based on a home network, etc., if needed.

The IPTV receiving device 60 may include the IPTV receiving device DRM component 62 mainly performing functions related to the protection of content, IPTV receiving device software/hardware components 64 performing functions related to the processing and usage of content and the like. The IPTV receiving device 60 may be, for example, an IPTV settop box or a network device equipped with a function corresponding to an IPTV settop box.

The IPTV receiving device DRM component 62 is authenticated and provisioned by the server side DRM system. After being loaded in a secure manner, the IPTV receiving device DRM component 62 may have its persistent values, necessary for its operation related to service security, initialized and then loaded securely. The IPTV receiving device DRM component 62 may obtain information associated with streams, which will be decrypted at the time of being serviced, and communicate with the server side DRM system 30 in order to exchange a key and rights therewith.

This IPTV receiving device DRM component 62 may include a decryption function therein or assist decryption performed by an external component included in the IPTV receiving device 60, for example, a specific hardware or software component of the IPTV receiving device.

The IPTV receiving device DRM component 62 may selectively operate depending on whether it includes software capable of performing a decryption function when MPEG2 packets or VoD packet streams are received.

For example, when the IPTV receiving device DRM component 62 includes software capable of performing a decryption function, it may receive MPEG2 packets or VoD packet streams from a server side and decrypt them through an internal processing. However, when the IPTV receiving device DRM component 62 does not include software capable of performing a decryption function, it may configure an external hardware component (e.g., a decryption engine, etc.), which will perform the decryption function, and securely exchange a key necessary for decryption with an external trusted hardware component. In this case, the decryption is performed by the hardware component.

Meanwhile, in the case in which the IPTV receiving device DRM component 62 does not have rights necessary to decrypt streams, it may notify the IPTV receiving device software/hardware components 64 of a corresponding message. In this case, the IPTV receiving device software/hardware components 64 may perform a procedure of displaying an error message or obtaining rights.

Further, the IPTV receiving device DRM component 62 may provide general authentication service for received messages or files (for example, EPG, IPG, etc.) not executable software.

The IPTV receiving device software/hardware components 64 are component of the IPTV receiving device other than the IPTV receiving device DRM component and may include a variety of software or hardware components performing functions for receiving IPTV service. For example, the IPTV receiving device software/hardware components may include, in terms of the functionality, a media player, a data receiving port, a storage (e.g., flash, hard disk, etc.), a home network output port, an encryption engine, a decryption engine, a filtering component, a user input module, a display module, a native authentication solution and the like and may be configured variously using software or hardware depending on implementation environments.

Meanwhile, the server side may transmit various data, related to secure download or secure messages, to the IPTV receiving device 60. In order to transmit the data, security solution authentication is required. Data requiring such security solution authentication may be largely divided into nonpersistent data and persistent data.

The nonpersistent data may refer to data used only for a reception time when the data is received by the IPTV receiving device 60. The security solution authentication is required in secure delivery, endtoend communication, etc. of EAS (Emergency Alert System) messages, onetime commands, etc., which are the nonpersistent data. Meanwhile, the persistent data may refer to data, which is persistent within the IPTV receiving device 60 even after a reception time. The security solution authentication is required in secure download of executable software, secure download of DRM codes, secure delivery of configuration files, update of a certificate hierarchy, and so on, which are the persistent data.

The security solution authentication includes a signing process and an authentication process. The signing process may be performed in specific systems of the server side, for example, a DRM system, etc. The authentication process may be performed in specific elements of the IPTV receiving device, for example, a native security solution, etc.

The native security solution may be provided in an IPTV receiving device in the form of hardware, software, or mixed hardware and software when the IPTV receiving device is manufactured. The native security solution may perform an authentication process for security solution authentication, integrity checking, DRM filtering and the like.

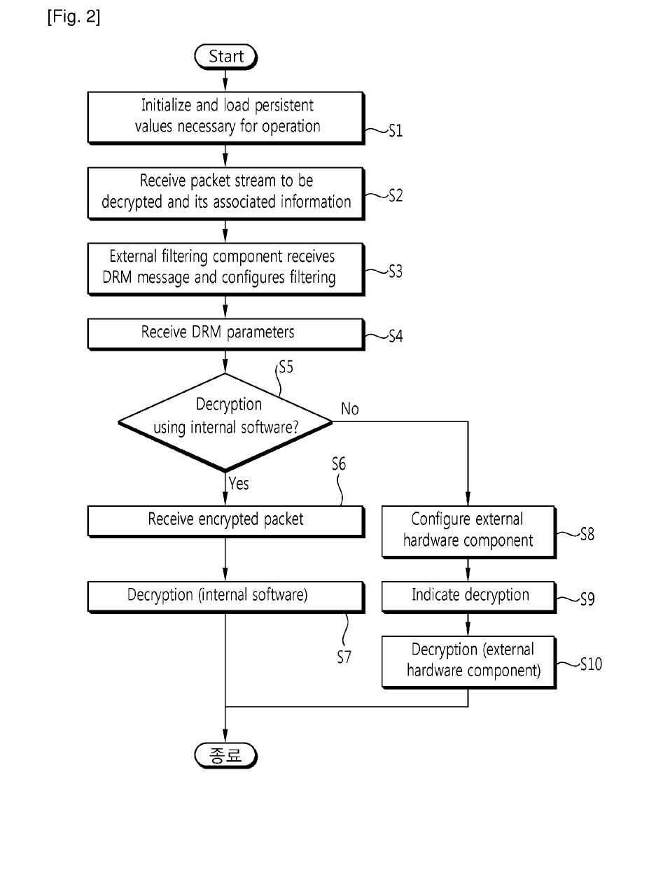

FIG. 2 is an exemplary view showing an operation of the IPTV receiving device DRM component in accordance with an embodiment of the present invention.

Referring to FIG. 2, the IPTV receiving device DRM component may be authenticated and provisioned by a specific entity of the server side, for example, the server side DRM system and may be loaded in a secure manner. The loaded IPTV receiving device DRM component may have its persistent values, necessary for its operation, initialized and securely loaded (step: S1).

For the purpose of IPTV service, an IPTV receiving device may request content guide information from a specific system of the server side, for example, the server side DRM system, the VoD server or the like. At this time, the content guide information is information guiding service content, supplementary information, etc. and may include, for example, EPG, IPG, VoD content guide, etc.

In response thereto, the server side may transfer the content guide information to the IPTV receiving device. Thus, the IPTV receiving device may receive the content guide information. At this time, the IPTV receiving device DRM component may execute authentication on the received content guide information. The IPTV receiving device DRM component may provide general authentication service for messages or files (for example, EPG, IPG, etc.) not executable software to the IPTV receiving device.

If a user selects a desired specific content to watch on the basis of the content guide information, the IPTV receiving device requests the corresponding content from a system of the server side (for example, the server side DRM system or the VoD server). In response to the request, the system of the server side transports encrypted packet streams (for example, MPEG2 packet streams, VoD packet streams, etc.), including the content, and its associated information to the IPTV receiving device.

The IPTV receiving device DRM component receives the packet streams, which will be decrypted, and the associated information from the system of the server side (step: S2). At this time, the associated information may include metadata of the content and so on. Further, the IPTV receiving device DRM component may receive a key to be used to decrypt the content, decryption rights, rights information to limit content usage or the like from the system of the server side while communicating with the DRM server in order to exchange a key and rights.

Meanwhile, the IPTV receiving device may receive DRM messages from the server side. The DRM messages may include a variety of DRM parameters for protecting the service. A filtering component within the IPTV receiving device receives DRM messages and performs filtering. The filtering component may be implemented using specific hardware. The IPTV receiving device DRM component may configure the reception and filtering of the DRM messages received by the filtering component (step: S3) and receives DRM parameters from the filtering component (step: S4). For example, the IPTV receiving device DRM component may receive ECM (Entitlement Control Message), etc. from a demux chip, i.e., an external filtering component within the IPTV receiving device.

Next, the IPTV receiving device DRM component determines whether it will decrypt the transmitted encrypted packets using software included therein or external trusted hardware, which is included in the IPTV receiving device, on the basis of the associated information (step: S5).

At this time, criteria for the determination of the IPTV receiving device DRM component about whether it will decrypt the encrypted packets directly or through external hardware may include the following examples.

1. Whether the IPTV receiving device DRM component includes software capable of decrypting encrypted packets. For example, in the case in which, as a result of search for internal software, software capable of decrypting received encrypted packets is included in the IPTV receiving device DRM component, the IPTV receiving device DRM component may decrypt the encrypted packets using the corresponding internal software. However, in the case in which, as a result of the search, software capable of decrypting the encrypted packets is not included in the IPTV receiving device DRM component, the IPTV receiving device DRM component may decrypt the encrypted packets through external hardware.

2. Depending on designation by information associated with packet streams. For example, in the case in which information associated with packet streams instructs that decryption be performed using internal software of the IPTV receiving device DRM component, the IPTV receiving device DRM component may perform decryption using the internal software. In the case in which information associated with packet streams instructs that decryption be performed using external hardware, the IPTV receiving device DRM component may perform description using the corresponding external hardware. Here, in the case in which, even though information associated with a packet stream instructs that decryption be performed using internal software, the internal software does not exist in information associated with packet streams, the IPTV receiving device DRM component may securely download corresponding software by requesting the software from a server system.

If, as a result of the determination (step: S5), it is determined that the IPTV receiving device DRM component will perform decryption using internal software, the IPTV receiving device DRM component receives the encrypted packets (for example, MPEG2 packets, VoD packets, etc.) (step: S6), checks rights information about pertinent content, and decrypts the packets using the internal software (step: S7). Accordingly, the decryption of the encrypted packets is performed by the IPTV receiving device DRM component itself.

However, if, as a result of the determination (step: S5), it is determined that the IPTV receiving device DRM component will perform decryption using external software, the IPTV receiving device DRM component may configure an external hardware component for decryption (e.g., it may pass a key and initialization conditions using external trusted decryption hardware) (step: S8), check rights information about pertinent content, and then instruct decryption of the packets (step: S9). At this time, the IPTV receiving device DRM component may exchange a key with the external hardware component securely. Accordingly, the decryption of the encrypted packets is performed by the corresponding external hardware (step: S10).

In the case in which there are no appropriate rights for decrypting the packet streams when the rights information is checked, the IPTV receiving device DRM component may transmit a notification message, informing this fact, to the IPTV receiving device. In this case, the IPTV receiving device may induce a user to purchase the content through a procedure of acquiring rights, for example, by informing the user that he cannot watch the corresponding content and displaying a screen on which the content may be purchased.

The IPTV receiving device DRM component may read and write parameters securely from a storage resource (e.g., flash or hard disk, etc.) of the IPTV receiving device. Further, the IPTV receiving device DRM component may retrieve unique identification information (e.g., a MAC address, a serial number, a unique identification number, etc.) from the IPTV receiving device.

Meanwhile, the IPTV receiving device may securely store the decrypted content in the storage, play back the content, and distribute it to external home devices. To this end, the IPTV receiving device must be able to protect the content through DRM.

Hereinafter, a series of processes of providing, storing and distributing content in the IPTV system are described. First, constituent elements of the IPTV system may be classified into a content provider domain, a service provider domain, a network provider domain, a consumer domain and the like in terms of domains. A system configuration of the each domain may be constructed in various ways depending on implementation environments. For example, each domain may include a plurality of systems (for example, a server, a device, a network, a software module, etc.) or a specific system may include a plurality of domains.

The content provider domain may include at least one content provider. The content provider may include an entity, which owns content or content assets or has a license for selling content or content assets. The content provider may provide content to a service provider. In typical IPTV service, a substantial primary source to consumers is a service provider, but, for rights management and protection of content, a content provider and consumers may be directly associated with each other, if appropriate.

The service provider domain may include at least one service provider. The service provider may include an entity, which is provided with content or content assets from a content provider and provides service to consumers. The service provider and the content provider may be managed and operated by the same service provider or different service providers.

The abovedescribed server side may be the service provider domain or a system, including the service provider domain and the content provider domain.

The network provider domain may include at least one network provider. The network provider may be an entity connecting a service provider and consumers for IPTV service, for example, a delivery system. The delivery system may include an access network using various network technologies, a core or a back network, etc. The network provider may provide a wired or wireless delivery system.

The consumer domain may refer to a domain that consumes IPTV service. The consumer domain may be constructed with various entities. For example, the consumer domain may include a home network. The home network may include one or more IPTV receiving devices, for example, an IPTV settop box, and may include a home device capable of sharing content and service with an IPTV receiving device, a network gateway for interfacing with a network provider domain and so on. The consumer domain may further include a wireless device such as a mobile device.

For IPTV service, when delivering content from a service provider domain to a consumer domain, the content may be protected using a service protection system, for example, a CAS (Conditional Access System). The content delivered to the consumer domain may be stored and rendered through an IPTV receiving device, such as an IPTV settop box, and redistributed to a home device, so that the content may be shared within the consumer domain. In order for the content to be shared securely within the consumer domain, a content protection system, for example, a DRM (Digital Rights Management) system may be used. Accordingly, a smooth association configuration between a service protection system and a content protection system is required.

An embodiment of association between a service protection system and a content protection system is described below. In the following embodiment, it is assumed that the service protection system is a CAS system and the content protection system is a DRM system.

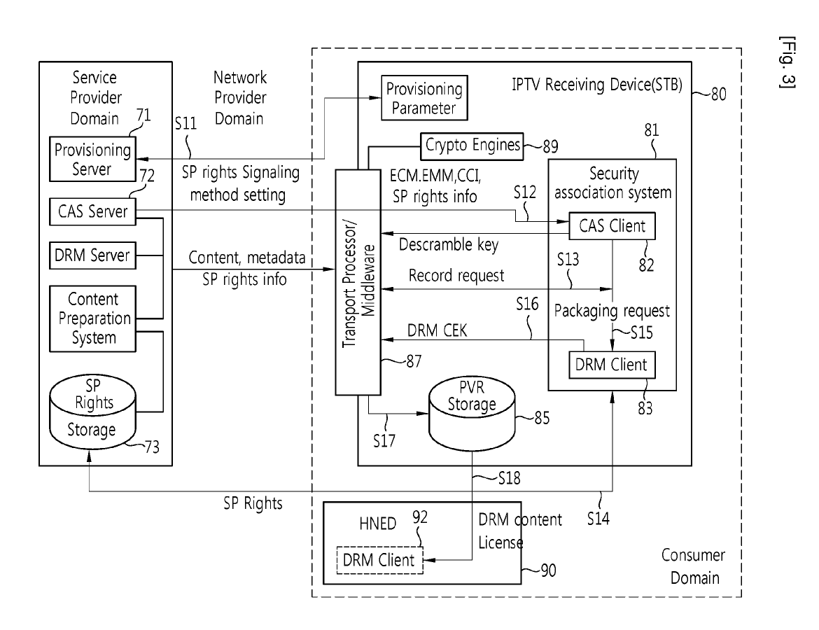

FIG. 3 is an exemplary view showing an association operation between a CAS system and a DRM system.

Referring to FIG. 3, first, a provisioning server 71 of a service provider domain sets provisioning parameters by associating with an IPTV receiving device 80 according to a preset protocol (step: S11). For example, a service provider may set and authenticate a signing method of service provider (SP) rights information through a provisioning protocol (SetParameterValues RPC) such as TR069 of a DRL.

Next, a CAS function is performed through association between a CAS server 72 and a CAS client 82. Serviced content is protected or the protection of serviced content is released through an ECM (Entitlement Control Message, an EMM (Entitlement Management Message), CCI (Copy Control Information) and the like (step: S12). At this time, an IPTV receiving device DRM component, for example, a security association system 81 may decrypt the content using internal software or instruct external hardware within the IPTV receiving device 80 to decrypt the content. Further, the IPTV receiving device DRM component may configure the reception and filtering of an ECM, an EMM, CCI, etc., which are performed by a filtering component of the IPTV receiving device 80, and receive parameters thereof.

Next, if there is a storage request for the content from a middleware 87 (step: S13), the security association system 81 may acquire service provider (SP) rights through a specific channel using service provider rights information (step: S14). For example, in the case in which the security association system 81 has received service provider rights information in URL information form, the security association system 81 may acquire service provider rights by accessing a SP rights storage 73 through, for example, an OOB channel.

In the case in which content storage rights have been assigned to the acquired service provider rights, the security association system 81 requests DRM packaging from a DRM client 83 (step: S15). The DRM client 83 delivers a CEK (Content Encryption Key), which is necessary for the packaging, to crypto engines 89 and requests the crypto engines 89 to encrypt the content (step: S16).

After the crypto engines 89 have performed the task requested by the DRM client 83, a PVR (Personal Video Recorder) storage 85 stores the encrypted content (step: S17). Thus, the security association system 81 may redistribute the encrypted content, which is stored in the PVR storage 85, to a home device 90 (step: S18). At this time, if a DRM client 92 of the home device 90 has a different kind of DRM from the DRM client 83 of the security association system 81, the security association system 81 may redistribute the content to the home device 90 using a DRM interoperable system, or download the same DRM client onto the home device 90 and then redistribute the content.

Meanwhile, a security component such as an IPTV receiving device DRM component, software necessary for service, content, etc. may be provided from a service provider domain to an IPTV receiving device in secure download form at an early stage and then operated and consistently updated. At this time, for secure download, a DSF (Downloadable Security Framework) system must be provided. A process of initializing this DSF is described below.

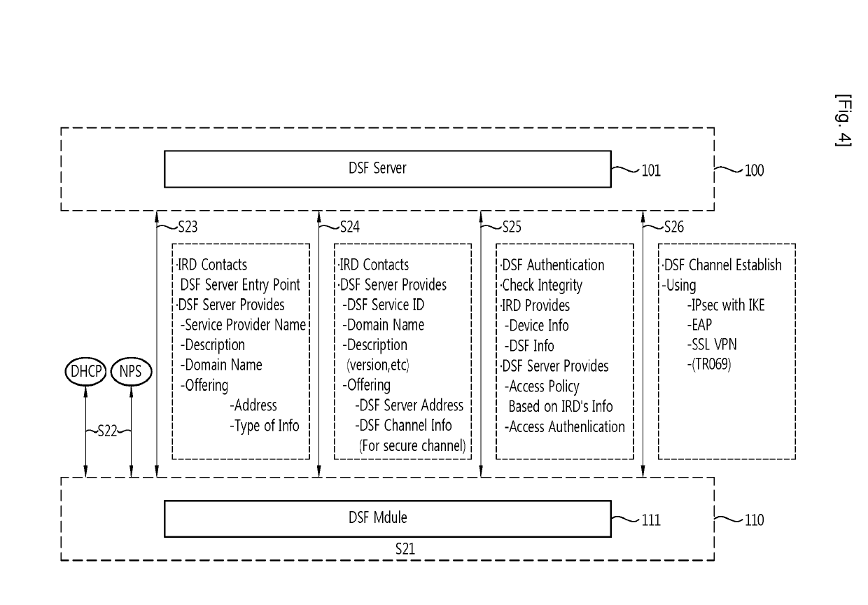

FIG. 4 is an exemplary view showing a DSF initialization procedure and illustrates constituent elements related to a DSF and an initialization operation flow thereof.

Referring to FIG. 4, a DSF system may include a DSF server 101 providing secure download service, a DSF module 111 associating with the DSF server 101 and providing a client function related to secure download service and so on. The DSF server 101 may be provided in a service provider domain 100, and the DSF module 111 may be provided in an IPTV receiving device 110 of a consumer domain. The DSF module 111 may be provided in the IPTV receiving device 110 in the form of an embedded module.

When a procedure begins, the IPTV receiving device 110 first initializes the DSF module 111 and its related modules (step: S21). After the initialization is completed, the IPTV receiving device 110 may perform provisioning through a DHCP (Dynamic Host Configuration Protocol), etc. (step: S22).

Next, the IPTV receiving device 110 may perform service provider discovery (step: S23). At this time, the IPTV receiving device 110 may access an entry point of the DSP server 101. The DSP server 101 may provide a ‘service provider name’, ‘description’, a ‘domain name’, ‘address’, ‘type of information’, etc. to the IPTV receiving device 110.

The IPTV receiving device 110 may then perform DSF discovery (step: S24). At this time, the IPTV receiving device 110 may gain access to the DSP server 101, and the DSF server 101 may provide a ‘DSF service ID’, a ‘domain name’, ‘description (version, etc.)’, a ‘DSF server address’, ‘DSF channel information’, and so on to the IPTV receiving device 110. The ‘DSF channel information’ may include information for forming a security channel.

The IPTV receiving device 110 and the DSP server 101 may mutually perform DSF verification (step: S25). For example, the IPTV receiving device 110 and the DSP server 101 may perform DSF authentication. Further, the IPTV receiving device 110 may check the integrity of the DSF module 101 and its related modules. The IPTV receiving device 110 may provide ‘device information’, ‘DSF information’, etc. to the DSP server 101. The ‘device information’ may include, for example, an OS (Operating System), configuration information, etc. of the IPTV receiving device 110. The DSF server 101 may provide an access policy on the basis of information received from the IPTV receiving device 110. The IPTV receiving device 110 and the DSP server 101 may also perform access authentication.

After such DSF verification is completed, the IPTV receiving device 110 and the DSF server 101 may establish a DSF channel (step: S26). As the DSF channel is established, the DSF server 101 and the DSF module 111 may perform secure download service while associating with each other.

An interface and procedures in which an IPTV receiving device and a home network end device may share content by configuring an interoperable domain being interoperable between not only the same DRMs, but different DRMs are described below.

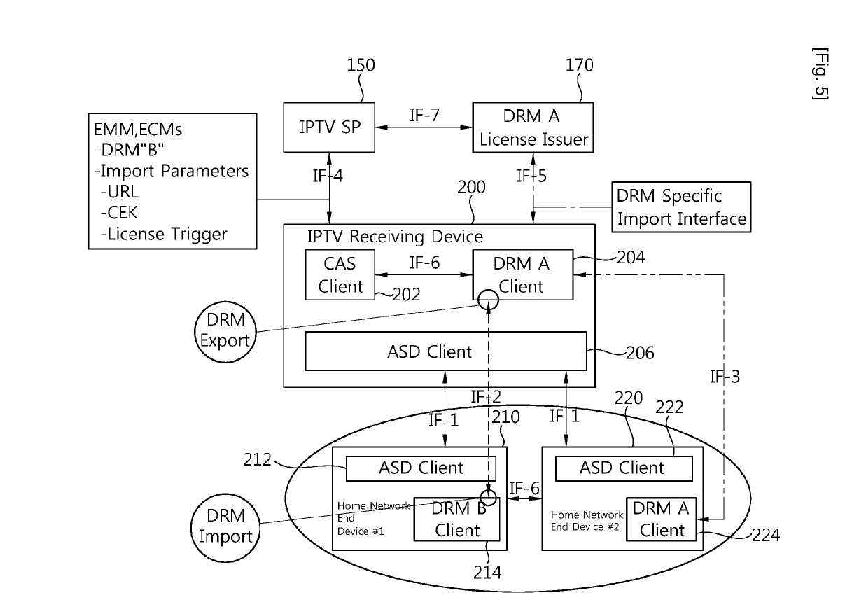

FIG. 5 is a diagram showing the architecture of an interoperable model.

As shown in FIG. 5, an IPTV receiving device 200, a first home network end device 210, and a second home network end device 220 include ASD (Authorized Service Domain) clients 206, 212, and 222, respectively. The IPTV receiving device 200 further includes a CAS client 202 and a DRM A client 204, the first home network end device 210 further includes a DRM B client 214, and the second home network end device 220 further includes a DRM A client 224. That is, the IPTV receiving device 200 and the second home network end device 220 support the DRM A, that is, the same DRM, and the first home network end device 210 supports the DRM B, which is a different DRM from the DRM A.

A first interface IF1 may be used by the ASD client in order to join in an ASD domain, leave from the ASD domain or upgrade the ASD domain. In order to share content downloaded by the CAS client, the IPTV receiving device 200 may use the first interface IF1 to safely transfer the content to devices within a network. This first interface IF1 may not be necessary when the IPTV receiving device 200 and a home network end device support the same DRM. The first interface IF1 may be satisfied by using a DRM interoperable mechanism, for example, DVBCPCM, Coral, etc.

The ASD client 206 of the IPTV receiving device 200 and the ASD client 212 of the first home network end device 210, and the ASD client 206 of the IPTV receiving device 200 and the ASD client 222 of the second home network end device 220 may interface with each other through the first interface IF1.

A second interface IF2 may perform a function of exporting content and a license from a DRM system, supported by the IPTV receiving device 200, to a DRM system supported by a home network end device (a different kind of a DRM system from that supported by the IPTV receiving device). For example, the DRM A client 204 of the IPTV receiving device 200 and the DRM B client 214 of the first home network end device 210, which support different DRMs, can interface with each other through the second interface IF2.

A third interface IF3 may refer to an interface specified for a specific DRM system. If the IPTV receiving device 200 and a home network end device support the same DRM system, they interface with each other through the third interface IF3. For example, the DRM A client 204 of the IPTV receiving device 200 and the DRM B client 224 of the second home network end device 220, which support the same DRM, may interface with each other through the third interface IF3.

A fourth interface IF4 may be used by the CAS client 202 in order to receive content and rights from the IPTV service provider 150. The fourth interface may transport pieces of DRM information required by the DRM A client 204 of the IPTV receiving device 200.

A fifth interface IF5 is an interface specified in the DRM system. For example, the fifth interface IF5 may be used by the DRM A client 204 based a file in order to call specific interfaces with a DRM A license issuer 170 defined in a file based DRM specification. For example, the fifth interface IF5 may refer to a DRM import interface that can be used for content protection through DRM.

A sixth interface IF6 is an interface, which is used by the CAS client 202 in order to safely distribute content, stored in the IPTV receiving device 200, to other devices within a home network. A function of the sixth interface IF6 may be satisfied by a DRM interoperable mechanism, for example, DVBCPCM, coral or the like.

A seventh interface IF7 is an interface of the server side. An IPTV service provider 150 may be used to request parameters, which are required to encrypt content into filebased DRMprotected content. In the seventh interface, the IPTV service provider 150 may receive the following metadata from the DRM A license issuer 170.

1. License issuer URL: It can be used to retrieve license information of encrypted content.

2. Content encryption key: It can be used to encrypt broadcasted content into file based DRM protected contents.

3. Content ID: A content ID may refer to a unique identifier for content encrypted in a DRM client.

4. Metadata field: An additional metadata field is required to encrypt broadcast content into a file based on a DRM system. The metadata field may include a group ID field, album metadata information or other pieces of information required by a DRM client encryption codec.

Hereinafter, a variety of scenarios for recoding broadcasted content within an IPTV receiving device are described.

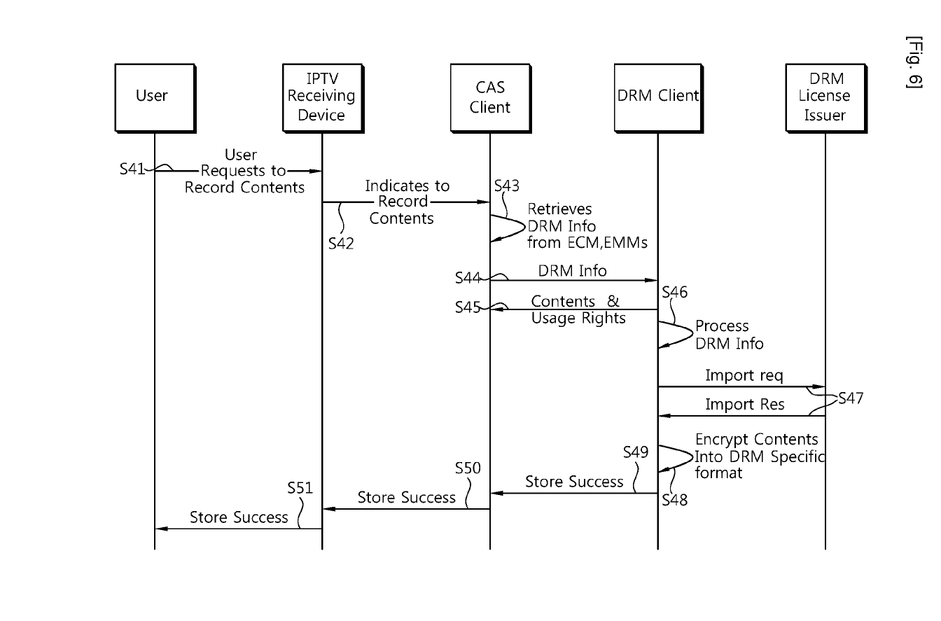

FIG. 6 is an exemplary view showing a scenario for recording broadcasted content within an IPTV receiving device and shows a case in which a DRM client calls a DRM import interface.

Referring to FIG. 6, a user may request an IPTV receiving device to record (for example, download and store) broadcasted content (step: S41). The IPTV receiving device that has received the request sends a signal, indicating the record of the content, to a CAS client (step: S42).

In response thereto, the CAS client retrieves DRM information from an ECM and an

EMM associated with the broadcasted content (step: S43). The DRM information may include a license issuer URL, a content encryption key, a content ID, a metadata field and so on.

Next, the CAS client sends the retrieved DRM information to a DRM client so that the DRM content can be converted into a DRMprotection contentbased file (step: S44). The CAS client may verify usage rights before extracting the DRM information. The usage rights may be received from the DRM client (step: S45).

The DRM client may process the DRM information received from the CAS client and verify the DRM information (step: S46). Next, the DRM client requests a license from a DRM license issuer by calling a DRM import interface and receives a response message therefrom (step: S47). The response message may include a valid license to meet a DRM format, and the DRM client may extract the license from the response message. The DRM import interface may refer to the abovedescribed fifth interface (IF5 of FIG. 5). The license issuer may form a partnership with an IPTV service provider.

Next, the DRM client encrypts the content into a file based on DRMspecific format and stores the license in an internal storage (step: S48). Thereafter, the DRM client sends a message, informing that the content has been successfully stored, to the CAS client (step: S49). The CAS client sends a message, corresponding to the received message, to the IPTV receiving device (step: S50). Accordingly, the IPTV receiving device may inform a user of this fact (step: S51).

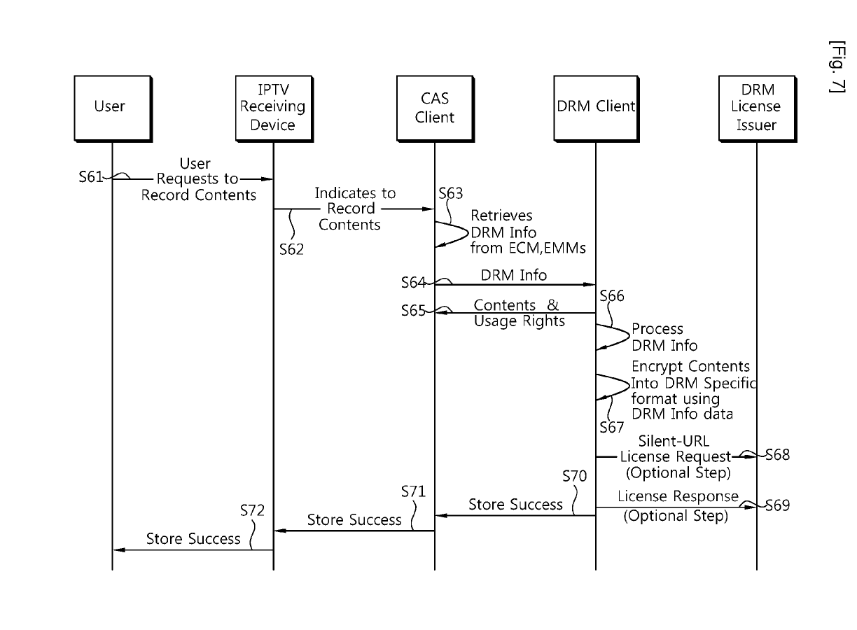

FIG. 7 is an exemplary view showing another scenario for recording broadcasted content within an IPTV receiving device and shows a case in which a DRM client does not call a DRM import interface.

Referring to FIG. 7, a user may request an IPTV receiving device to record (for example, download and store) broadcasted content (step: S61). The IPTV receiving device that has received the request sends a signal, indicating the record of the content, to a CAS client (step: S62). In response thereto, the CAS client retrieves DRM information from an ECM and an EMM associated with the broadcasted content (step: S63). The DRM information may include a license issuer URL, a content encryption key, a content ID, a metadata field and so on.

Next, the CAS client sends the retrieved DRM information to a DRM client so that the DRM content can be converted into a DRMprotection contentbased file (step: S64). The CAS client may verify usage rights before extracting the DRM information. The usage rights may be received from the DRM client (step: S65).

The DRM client may process the DRM information received from the CAS client and verify the DRM information (step: S66). The DRM client then encrypts the content into a file based on a DRMspecific format using the DRM information (step: S67). At this time, the DRM client does not call a DRM license issuer for a DRM import interface unlike the above example. As an option, the DRM client may call a license request interface from the DRM license issuer based on an URL provided from the DRM information (step: S68, S69).

The DRM client sends a message, informing that the content has successfully been converted into a DRMprotected format, to the CAS client (step: S70). The CAS client sends a message, corresponding to the received message, to the IPTV receiving device (step: S71). Accordingly, the IPTV receiving device may inform a user of this fact (step: S72).

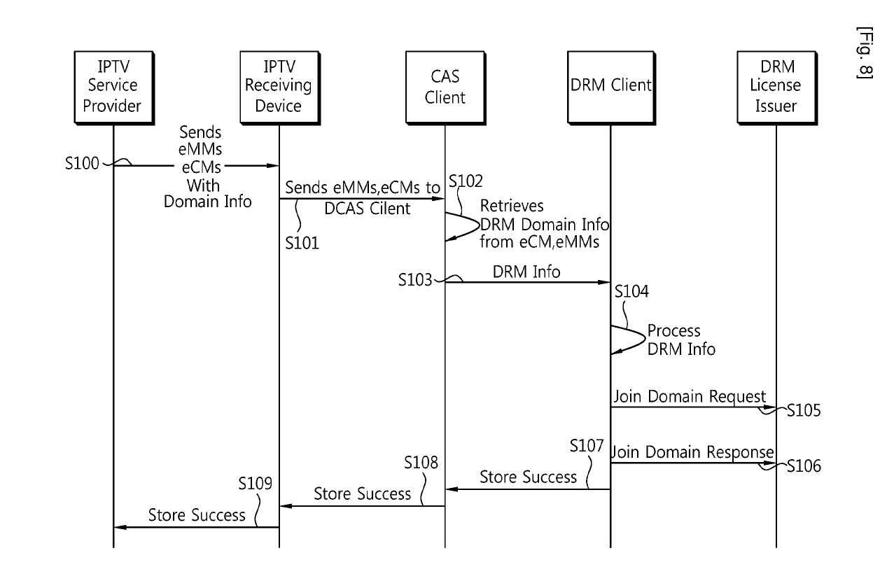

FIG. 8 is an exemplary view showing a scenario for joining an IPTV receiving device in a permitted DRM interoperable domain or a permitted DRM domain.

Referring to FIG. 8, first, an IPTV service provider requests an IPTV receiving device to join a DRM domain or a DRM interoperable domain. At this time, the IPTV service provider sends an EMM or ECM, including domain information necessary for the IPTV receiving device, to the IPTV receiving device (step: S100).

The IPTV receiving device receives the domain information, included in the EMM or ECM, retrieves the domain information from the EMM or ECM by decoding the domain information (step: S 102), and sends the retrieved domain information to a DRM client within the IPTV receiving device (step: S103).

The DRM client receives, verifies and processes the domain information (step: S104) and calls a join domain interface specified by DRM (step: S105, S106). For example, the DRM client may send a join domain request message, requesting that a DRM license issuer join the domain (step: S105), to the DRM license issuer and receive a response therefrom (step: S106).

If information, indicating that the DRM license issuer has successfully joined the domain, is included in the response, the DRM client sends a message, indicating that the DRM license issuer has successfully joined the domain, to the CAS client (step: S107). The CAS client sends the corresponding message to the IPTV receiving device (step: S108). Accordingly, the IPTV receiving device may inform a user that the IPTV receiving device has successfully joined the domain (step: S109).

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A data processing method employing a DRM component of an IPTV receiving device, the data processing method comprising the steps of:
receiving information associated with a packet to be decrypted from a server; and
decrypting the packet by performing any one of its own decryption and decryption using external hardware,
wherein in the case in which the its own decryption is performed, the DRM component receives the packet and decrypts the packet using internal software, and in the case in which the decryption using the external hardware is performed, the DRM component exchanges a key with an external trusted hardware component within the IPTV receiving device.

2. The data processing method of claim 1, further comprising the steps of:
configuring reception and filtering of a DRM message, which are performed by an external component within the IPTV receiving device; and
receiving DRM parameters from the external component.

3. The data processing method of claim 1, further comprising the step of communicating with a DRM server in order to exchange a key and rights necessary for the decryption.

4. The data processing method of claim 1, further comprising the steps of:
a DRM server authenticating and provisioning the DRM component; and
initializing persistent values necessary for an operation and safely loading the persistent values.

5. The data processing method of claim 1, further comprising the step of determining whether the its own decryption or the decryption using the external hardware will be performed based on the received information.

6. The data processing method of claim 5, wherein the determination step is performed by determining whether internal software capable of performing the decryption of the packet or based on specification by the received information.

7. The data processing method of claim 1, further comprising the step of, in the case in which there are no appropriate rights for decrypting the packet, informing this fact of the IPTV receiving device through a specific message.

8. An IPTV receiving device, comprising:
hardware component; and
a DRM component receiving information associated with a packet to be decrypted from a server, and decrypting the packet by performing any one of its own decryption and decryption using external hardware,
wherein in the case in which the its own decryption is performed, the DRM component receives the packet and decrypts the packet using internal software, and in the case in which the decryption using the external hardware is performed, the DRM component exchanges a key with the hardware component.

9. The IPTV receiving device of claim 8, further comprising a filtering component for receiving and filtering a DRM message,
wherein the DRM component configures reception and filtering of the DRM message, which are performed by the filtering component, and receives DRM parameters from the filtering component.

10. The IPTV receiving device of claim 8, wherein the DRM component determines whether the its own decryption or the decryption using the external hardware will be performed based on the received information.
